(19) United States
(12) Patent Application Publication
(10) Pub. No.: US 2020/0305365 A1
(43) Pub. Date: Oct. 1, 2020

(54) MODULAR WIRELESS SPRINKLER AND IRRIGATION SYSTEM

(71) Applicants: PAT M. SHERRILL, WIKIEUP, AZ (US); CURTIS CLARK-SHERRILL, WIKIEUP, AZ (US)

(72) Inventors: PAT M. SHERRILL, WIKIEUP, AZ (US); CURTIS CLARK-SHERRILL, WIKIEUP, AZ (US)

(21) Appl. No.: 16/541,915

(22) Filed: Aug. 15, 2019

Related U.S. Application Data
(60) Provisional application No. 62/722,680, filed on Aug. 24, 2018.

(51) Int. Cl. A01G 25/16; A01G 25/02; G05B 15/02; G05B 19/18

(52) U.S. Cl. CPC A01G 25/16; A01G 25/02; G05B 2219/2625; G05B 19/18; G05B 15/02

(57) ABSTRACT

A control box for a sprinkler or irrigation systems has a housing with a base and a set of sidewalls. A cover is removably secured to the housing. A solar panel is positioned on the cover. One or more rechargeable batteries are stored in the housing that are recharged by the solar panel. A control module is powered by the one or more rechargeable batteries. The control module is configured to generate control signals that actuate one or more flow control valves in the sprinkler or irrigation system.

### RELATED APPLICATIONS

This patent application is related to U.S. Provisional Application No. 62/722,680 filed Aug. 24, 2018, entitled “A MODULAR WIRELESS SPRINKLER AND IRRIGATION SYSTEM” in the name of Pat M. Sherrill, and which is incorporated herein by reference in its entirety. The present patent application claims the benefit under 35 U.S.C § 119(e).

### FIELD OF THE INVENTION

The present invention in general relates to sprinkler and irrigation systems and in particular, to a modular wireless control box for deploying a scalable sprinkler or irrigation system.

### BACKGROUND OF THE INVENTION

Automated and remote-controlled sprinkler and irrigation systems are now widely available and have proven to provide major labor savings while preserving precious water resources. Automated and remote-controlled sprinkler and irrigation systems enable users to conveniently irrigate large areas with little manual effort.

Typical systems include a plurality of valves and sprinkler heads in fluid communication with a water source, and a centralized controller connected to the water valves. The sprinkler heads are generally strategically spaced or positioned about or within an area to be irrigated. At appropriate times the controller opens one or more of the normally closed valves to allow water to flow from the water source to the sprinkler heads. Water then issues from the sprinkler heads in predetermined fashion to the area to be irrigated. Sprinkler and irrigation systems are generally installed to provide irrigation to lawns, gardens, and planted areas, in residential and business park environments. Irrigation systems are also commonly used in agricultural settings for watering crops.

In the past, sprinkler system controllers where mechanical in nature. In other words, mechanical clock mechanisms drive one or more controller wheels having pins, cams, etc. mounted thereon which operate the sprinkler station switches. The controller wheels of such apparatus are typically marked with the parameter being controlled such as the time of day or day of the week. The activation pins, cams, etc, are movable by the operator so as to “program” the controller to operate in the desired manner.

While some may still use mechanical sprinkler controllers, the use of electrical controllers as, a means for selective control of valves in irrigation systems is more currently more common. Such controllers may have an electronic timer which may be coupled, to solenoid valves which are in turn connected to the sprinkler heads. While electronic, these controllers generally include a manually set able timing or measuring mechanism to enable irrigation on a programmed or preplanned basis.

Unfortunately, existing approaches for modifying the behavior of electronic controllers at an irrigation site involved complicated communication and computational systems and also entail significant additional communications and computational costs to the users and operators of such systems. Most of these systems do not permit control by a remote operator or transmitter for added convenience.

Advancements in personal wireless communication devices, such as smartphones and tablets, may allow for an increased level of remote monitoring and control of sprinkler and irrigation systems. However, despite the advancements in sprinkler and irrigation systems, there still exists a need for improved systems and methods for building, maintaining, and controlling sprinkler and irrigation systems.

Therefore, it would be desirable to provide a system and method that overcome the above problems. The system and method would provide a wireless control box for a sprinkler system that may be remotely programmed and operated using wireless devices illustratively including smartphones and tablets, or with wired networked devices illustratively including a desktop computer.

### SUMMARY

This summary is provided, to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a control box for a sprinkler or irrigation systems is disclosed. The control box has a housing with a base and a set of sidewalls. A cover is removably secured to the housing. A solar panel is positioned on the cover. One or more rechargeable batteries are stored in the housing that are recharged by the solar panel. A control module is powered by the one or more rechargeable batteries. The control module is configured to generate control signals that actuate one or more flow control valves in the sprinkler or irrigation system.

In accordance with one aspect of the present application, a sprinkler or irrigation system is disclosed. The sprinkler or irrigation system has one or more distribution stations each configured to be joined with a control box, each of the distribution stations having a distribution box or valve control box that house said one or more flow control valves. The control box has a housing with a base and a set, of sidewalls. A cover is removably secured to the housing. A solar panel is positioned on the cover. One or more rechargeable batteries are stored in the housing that are recharged by the solar panel. A control module is powered by the one or more rechargeable batteries. The control module is configured to generate control signals that actuate one or more flow control valves in the sprinkler or irrigation system.

### BRIEF DESCRIPTION OF THE DRAWINGS

FIG. 1 is a cross-sectioned side view of a control unit in accordance with an embodiment of the invention;

FIG. 2 is a top down view of the control unit of FIG. 1 with the cover removed in accordance with an embodiment of the invention;

FIG. 3A is a perspective view of the control unit of FIG. 1 installed in a valve control box or distribution box in accordance with an embodiment of the invention;

FIG. 3B is a cross-sectioned side view of the control unit of FIG. 1 installed in a valve control box or distribution box in accordance with an embodiment of the invention;

FIG. 4 illustrates a top down view of the valve placement in the valve control box or distribution box of FIG. 3 in accordance with an embodiment of the invention;

FIGS. 5A and 5B are photographs of the valve control box or distribution box of FIG. 3 with the cover removed during an in ground installation in accordance with an embodiment of the invention;

FIG. 6 is a block diagram of a modular wireless sprinkler system in accordance with one embodiment of the present invention;

FIG. 7 is a block diagram of a computing device used in the modular wireless sprinkler system of FIG. 6 in accordance with one embodiment of the present invention; and

FIGS. 8-19 show different application pages which may be displayed on a computing device using the system of FIG. 6 in accordance with one embodiment of the present invention.

### DETAILED DESCRIPTION OF THE PREFERRED EMBODIMENTS

The present invention has utility as a modular wireless control box for deploying a scalable sprinkler or irrigation system. Inventive embodiments of the modular wireless control box may be remotely programmed and operated using wireless devices illustratively including smartphones and tablets, or with wired networked devices illustratively including a desktop computer. Embodiments of the inventive modular wireless control box may also be integrated into a whole home wireless system or smart home featuring devices with voice recognition that are operated using voice commands to execute commands or, requested actions. In areas were cell phone or Internet services are either intermittent or not available, specific embodiments of the control box may be manually programed with a control interface on the control box, where each control box may have an internal clock.

Embodiments of the inventive control box may be powered by a solar panel that provides energy for operation of the control box during the day, and maintains the charge of a battery backup system that may be housed in the control box. The one or more batteries of the battery backup system may be rechargeable, and die batteries may be relied on to run the one or more control boxes in a sprinkler or irrigation system at night and on dark cloudy days. In a specific inventive embodiment, the backup battery system may be relied on to run a set of flow control valves for up to 180 days under daily use conditions without any charge from the solar panel. Embodiments of the inventive control box may alert a user via their communication device, smart device, or computer if the solar panel ceases to charge the batteries, and the control box may be set to alert one or more designated users if the charge falls below 50% power. These alert features make embodiments of the inventive control box system particularly useful for second homes that may be vacant for extended periods of time.

Embodiments of the inventive control box may be ruggedized to be used above ground at development and/or construction sites. Specific inventive embodiments of the control box may be equipped with quick disconnects for temporary installations of a sprinkler or irrigation system. The housing of the control box that protects the operating control module and battery backup system may be designed to be water and airtight, even under conditions where the entire control box is submerged in water.

Embodiments of the inventive control box may be equipped with a digital volume and pressure meter, which may be integrated in the control module that allows a sprinkler or irrigation system to establish a baseline volume and pressure for each station and the supply line in the system. The established baseline volume and pressure feature allows for alerts to be generated if a pressure drop is detected that may indicate a leak in the system. Subsequently, the alert may be sent to a smart device, tablet, or networked computer that a potential or probable leak has occurred in the system.

In specific installations where multiple control boxes have been installed, and each of these control boxes each work with and control a separate assigned valve control box, the control boxes may be coded to differentiate which control box is assigned to a specific valve control box. The assigned code may be a single digit or a unique security code. In instances where a unique security code has been assigned, as for example by the manufacturer of the control box, an unlimited number of control boxes may be added to a sprinkler or irrigation system that are separately and uniquely addressable by the user.

For example, in a landscape were multiple control boxes have been installed, in order to work with a particular valve control box with a valve set, a user may just enter the security code or a single digit which can be assigned for a single entry. When an application (app) is opened on a user device, an interactive map may show the location of all the control boxes in the landscape with the security code being listed above each control box shown on the map.

In an inventive embodiment in which a valve control box contains more than one flow valve, the control box assigned to the valve control box may control the separate valves together or each flow valve may be opened or closed independently as entered by the user via the app or as programmed at the control box itself.

In a specific inventive embodiment, weather alerts may be incorporated into the app that temporarily postpone or delay a scheduled watering session based on the predicted weather forecast for precipitation. The watering sessions may be automatically changed or may rely on a user confirmation to postpone or delay the watering session. Weather information may be obtained from recognized weather agencies or services. For example, four temporary sleep options of 12 hours, 24 hours, 36 hours, and 48 hours may be set based on the weather forecast. It is appreciated that other periods of time may be set. The control box system will reawaken when the chosen sleep time has elapsed.

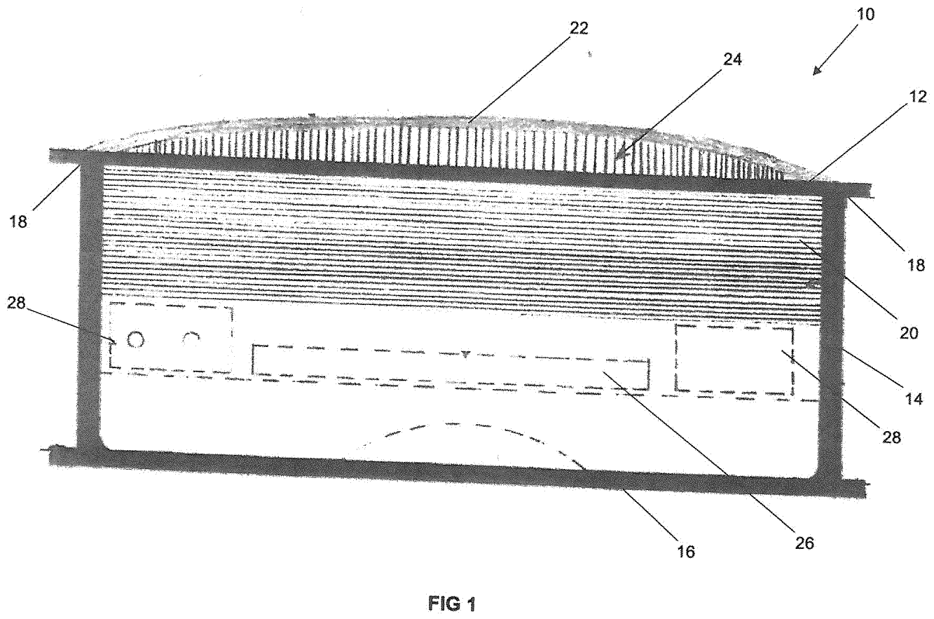

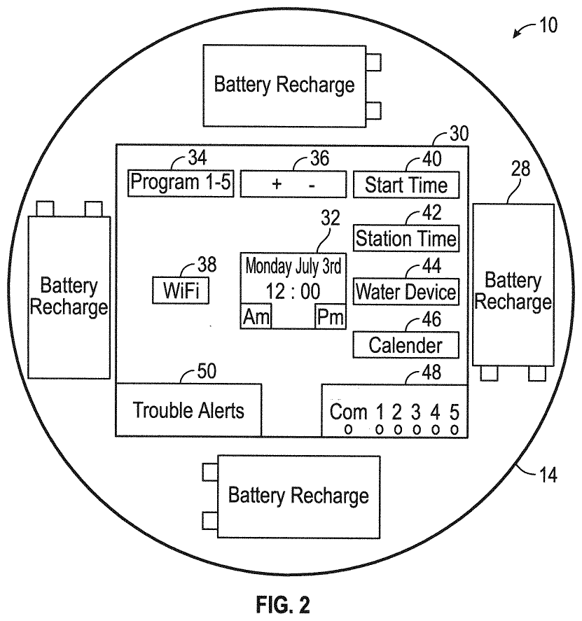

Referring now to the figures, FIG. 1 is a cross-sectioned side view of an embodiment of a control unit 10. The control unit 10 has a housing formed with a cover 12 and a base 16 with adjoining sidewalls 14 that are sealed to the cover 12 with a gasket 18. A set of threads 20 may secure the cover 12 to the sidewalls 14. A solar panel 22 may be positioned on the top of the cover 12 to provide power to one or more rechargeable batteries 28. A layer of insulation 24 may be positioned between the solar panel 22 and the lid 12. The housing may be in the shape of a cylindrical can as best shown in the top down view in FIG. 2 with the circular sidewall 14. The one or more rechargeable batteries 28 and a control module 26 may be housed in the housing. A protective cover 10A may be positioned over the control unit 10 to protect the control unit 10 from the elements.

As shown in FIG. 2, the control module 26 may have a top facing control panel 30, which may be a touch panel display or have discreet buttons as described as follows for controlling one or more underlying flow control valves. A clock 32 may be adjusted and set with increment buttons 36 for each on/off program for each flow control valve as chosen by button 34, which in the example shown is for controlling five separate flow control valves numbered 1 to 5. Indicator 38 shows if a communication signal such as WiFi, cellular or the like is available. Button 40 is used to set the start time. Button 42 is for setting the station time. Button 44 is used to set the watering days. Button 46 is used to set or display the calendar. Button 48 is used to select between the stations. Button 50 indicates a trouble alert. The control module 26 may be coupled to a communication module 52. The communication module 52 may be used to send wireless signals to and from the control module 26. The wireless signals may be used to communicate operating status of the control unit 10 to one or more electronic devices as well, as for allowing the electronic devices to program the control module 26 as will be described below.

In accordance with one embodiment, the control module 26 may be removable. This may allow one to remove the control module 26 to program the control module 26 in a more desirable location.

It should be noted that FIG. 2 shows one embodiment. The housing may be other geometrical shapes without departing from the spirit and scope of the present invention. As maybe shown below.

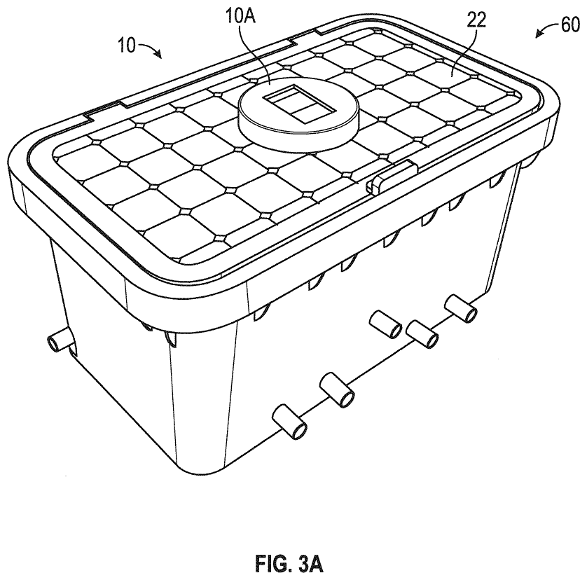

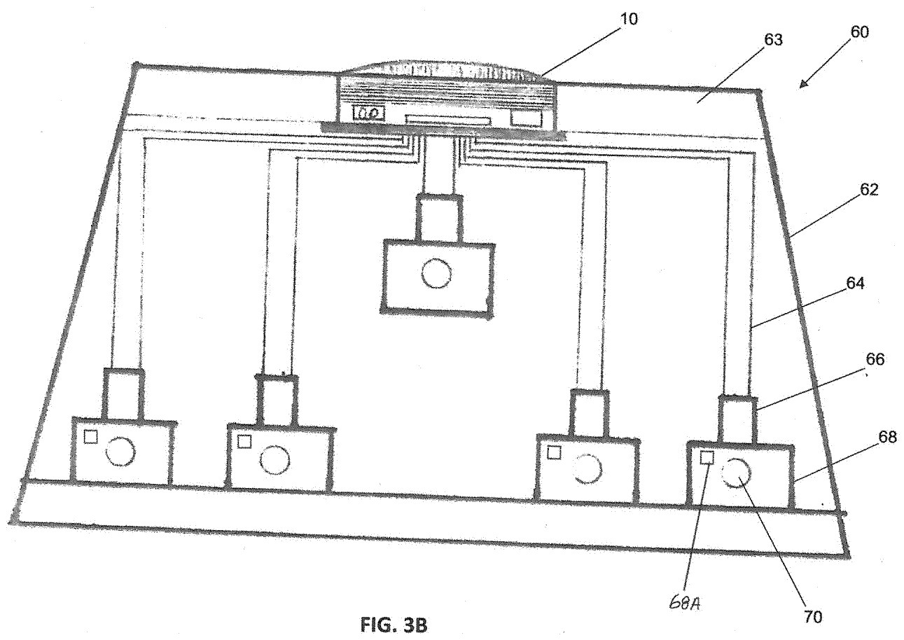

Referring to FIG. 3A-3B, a distribution station 60 having the control unit 10 installed in a cover 63 of a distribution box or valve control box 62 may be seen. In this embodiment, the valve control box 62 has a rectangular geometric configuration. However, other geometric configurations may be used without departing from the spirit and scope of the present invention. In this embodiment, the solar panel 22 may be positioned on the top of the cover 63 of the control box 62 and not on the cover of the control unit 10. A series of control line electrical wires 64 provide actuation signals to each of the one or more valve motors 66 that actuate the opening and closure of the valves 68. In the example shown, five individual valves 68 are housed in the distribution box or valve control box 62.

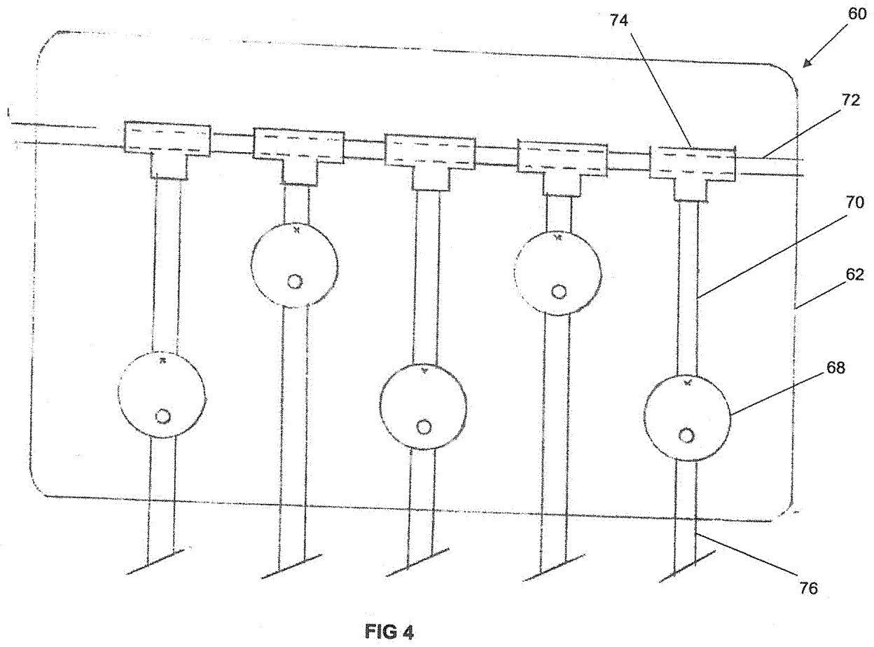

Each of the valves 68 may have one or more sensors 68. In accordance with one embodiment the sensors 68 may be a digital volume and pressure meters. The sensors may communicate with the control unit 10 to supply current volume and pressure readings for each valve 68. An established baseline volume and pressure feature allows for alerts to be generated if a pressure drop is detected that may indicate a leak in the system. Subsequently the alert may be sent to a smart device, tablet, or networked computer that a potential or probable leak has occurred in the system. FIG. 4 illustrates a top down view of the distribution station 60 with the valve 68 placement in the distribution box or valve control box 62 of FIG. 3. As shown the valves 68 are offset to facilitate the removal of malfunctioning valves without having to dig up the distribution box or valve control box 62. A main fluid supply line 72 feeds into the distribution box or valve control box 62. Taps 74 supply fluid to nipples 70 that are in fluid communication with the flow control valves 68 that control the flow of fluid to pipes 70 that extend outward from the distribution station 60 to associated sprinklers (not shown) or irrigation lines (not shown). In a specific embodiment the nipples are made of schedule 80 polyvinyl chloride (PVC).

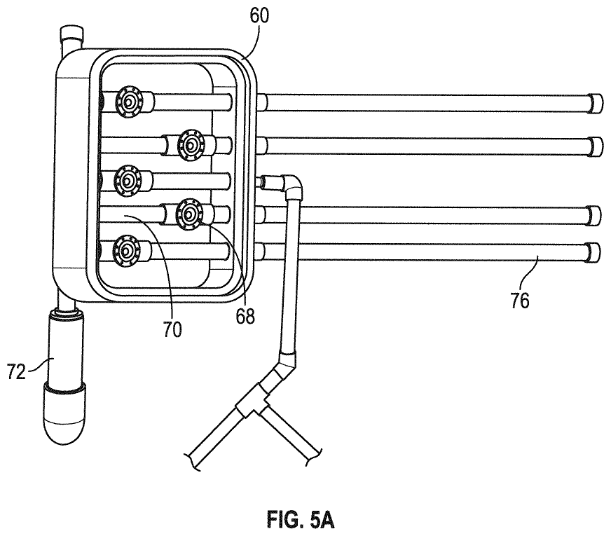

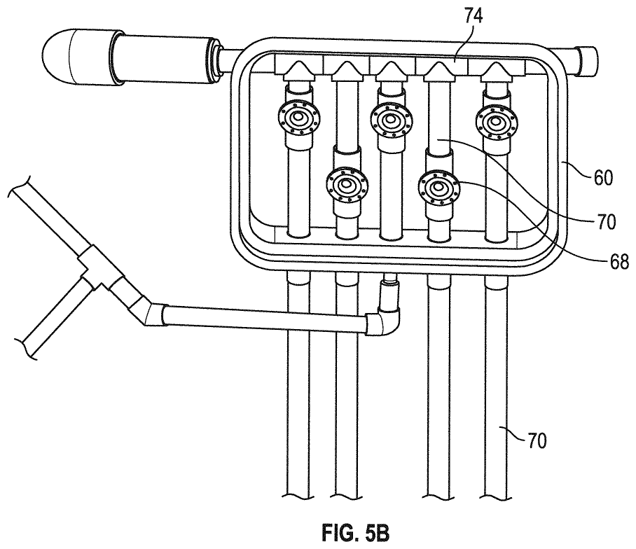

FIGS. 5A and 5B are photographs of distribution station 60 with the distribution box or valve control box 62 with the cover 63 removed during an in ground installation.

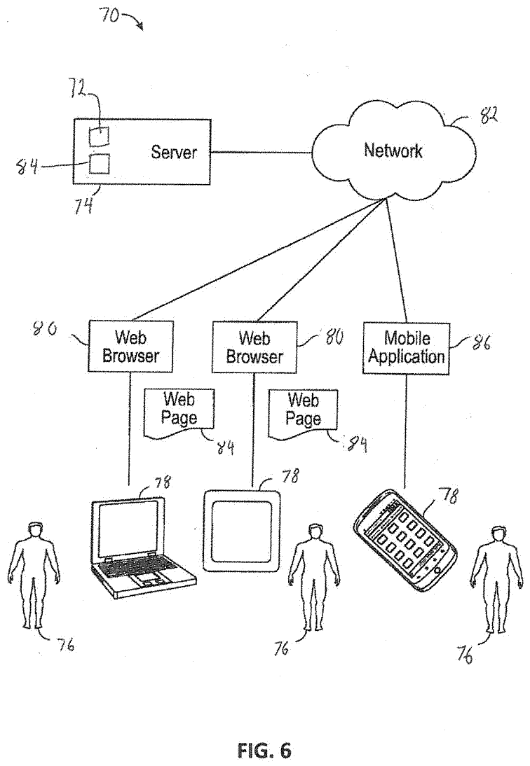

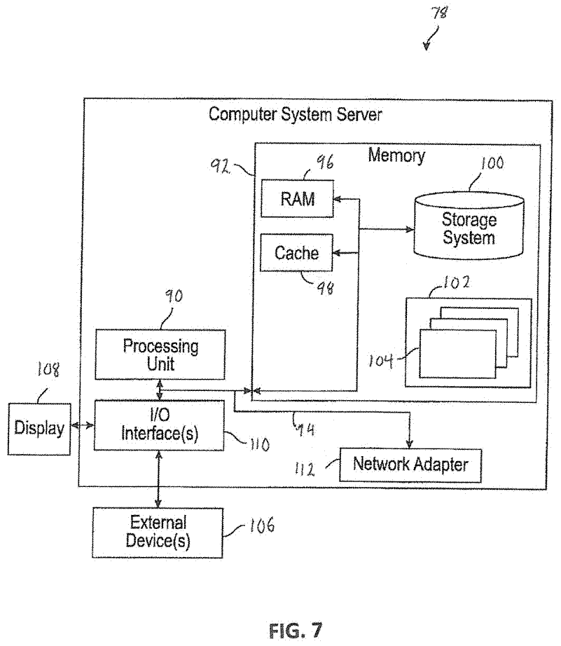

Referring now to FIG. 6, a system 70 may be shown. The system 70 may provide a sprinkler system control platform 72 that may allow for wireless communication between one or more distribution stations 60 and one or more one or more computing devices 78. The system 70 may have a server 74. The server 74 may be used to host the sprinkler system control platform 72. Individuals 76 may use one or more computing devices 78 to access the sprinkler system control platform 72 that may be hosted on the server 74. The computing devices 78 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 78 may be described in the general context of computer system executable instructions, such as program modules, being executed by a computer system as may be described below.

The computing device 78 may be loaded with an operating system. The operating system of the computing device 78 may manage hardware and software resources of the computing device 78 and provide coma on services for computer programs running on the computing device 78. The computing device 78 may be loaded with a web browser 80. The web browser 80 may allow the computing device 78 to gain online access to a network 82 such as the World Wide Web. The web browser 80 may be Microsoft® Internet Explorer, Google® Chrome, Mozilla® Firefox, Apple® Safari or similar browsing applications. By connecting to the network 82, the computing device 78 may access a website 84 associated with the sprinkler system control platform 72 hosted on the server 14.

Alternatively, or in addition to, the computing device 78 may download a mobile application 86. The mobile application 86 may access and communicate with the sprinkler system control platform 72 hosted on the server 74. By connecting to the network 82, the computing device 18 may access and communicate with the sprinkler system control platform 72 hosted on the server 74 via the mobile application 86.

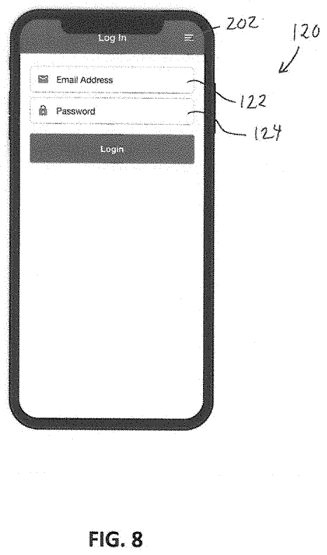

Referring now to FIG. 8, the computing devices 78 may be described in more detail in terms of the machine elements that provide functionality to the systems and methods disclosed herein. The components of the computing devices 78 may include, but are not limited to, one or more processors or processing units 90, a system memory 92, and a system bus 94 that couple various system components including the system memory 92 to the processor 90. The computing devices 78 may typically include a variety of computer system readable media. Such media could be chosen from any available media that is accessible by the computing devices 78, including non-transitory, volatile and non-volatile media, removable and non-removable media. The system memory 92 could include one or more computer system readable media in the form of volatile memory, such as a random access memory (RAM) 96 and/or a cache memory 98. By way of example only, a storage system 100 may be provided for reading from and writing to a non-removable, non-volatile magnetic media device typically called a “hard drive”.

The system memory 92 may include at least one program product/utility 102 having a set (e.g., at least one) of program modules 104 that may be configured to carry out the functions of embodiments of the invention. The program modules 104 may include, but is not limited to, an operating system, one or nose application programs, other program modules, and program data. Each of the operating systems, one or more application programs, other program modules, and program data or some combination thereof, may include an implementation of a networking environment. The program modules 104 generally carry out the functions and/or methodologies of embodiments of the invention as described herein. For example, the program modules 104 may carry out the steps for communicating with and controlling the distribution stations 60 as will be described below.

The computing device 78 may communicate with one or more external devices 106 such as a keyboard, a pointing device, a display 108, and/or any similar devices (e.g., network card, modern, etc.) that enable the computing device 78 to communicate with the server 74 (FIG. 6), Such communication may occur via Input/Output (I/O) interfaces 100. Alternatively, the computing devices 78 may communicate with one or more networks such as a local area network (LAN), a general wide area network (WAN), and/or a public network (e.g., the network 82 shown in FIG. 6) via a network adapter 112. As depicted, the network adapter 112 may communicate with the other components of the computing device 78 via the bus 94.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 100) may be utilized. in the context of this disclosure, a computer readable storage medium may be any tangible or non-transitory medium that can contain, or store a program (for example, the program product 102) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Referring to the FIGs, one embodiment of operation of the sprinkler system control platform 72 may be described. To access the sprinkler system control platform 72, individuals 76 may access the webpage 84 or download the mobile application 86 via a computing device 78. The mobile application 76 may be downloaded from iTunes®, Google Play®, Apotide® or other similar mobile application download sites. Once the individual 76 accesses the webpage 84 or opens the mobile application 86, the individual 86 may see a login screen 120 as shown in FIG. 8. The login screen 120 may have a User ID/email area 122 and a password area 124.

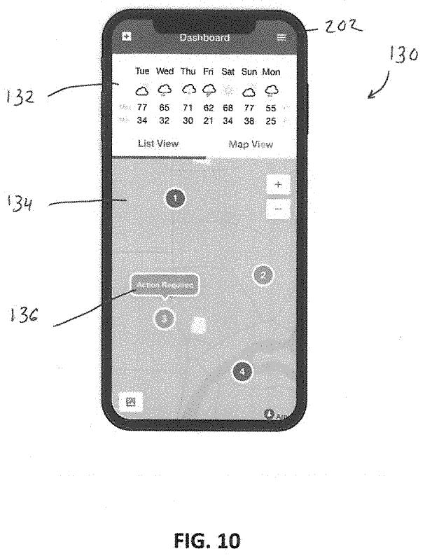

Once the individual 76 enters the corresponding user/email information in the User ID/email area 122 and the password area 124, the individual 76 may press the Login button 126 using an external device 106 (i.e. keyboard, mouse, etc.) of the computing device 78. The user information may be sent to the server 74 hosting the sprinkler system control platform 72 for verification. If the user information of the individual 76 is verified, the individual 16 may be sent to a personalized dashboard page 130 shown in FIG. 10 which may be described below. A link may be provided if the individual 76 cannot remember his/her User ID/password. By selecting the link, the individual 76 may be sent to reset password page. The login screen 120 may have a link to review the terms and conditions of signing up and accessing the sprinkler system control platform 72. In accordance with one embodiment, the login screen 120 may have an area to allow the individual 16 to remain logged in and to go the personalized dashboard page 130. Thus, when the individual 76 accesses the webpage 84 or opens the mobile application 86 via the computing device 78, the individual 76 may be sent directly to the personalized dashboard page 130. In this manner, the individual 76 may not have to go through the login screen 120.

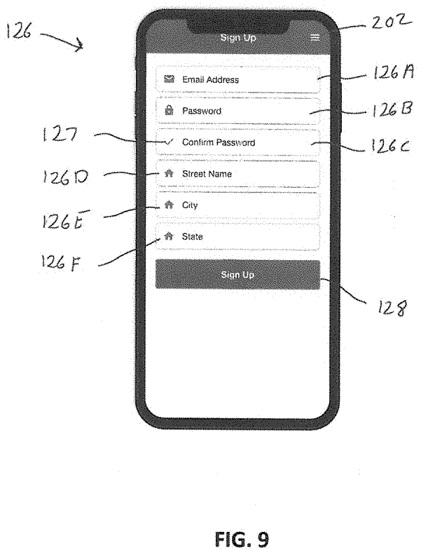

If the individual 76 is new to the sprinkler system control platform 72, the individual 76 may be first sent to a Registration page 126 as shown in FIG. 9 to register and become a member of the sprinkler system control platform 72. The registration page 126 may have a User ID/email area 126A for entering a User ID of the individual 76. In accordance with one embodiment the User ID may be an email address of the individual 76. Once the individual 76 has entered the information in the User ID/email area 72 may then enter a password for the USER ID in a password area 126B. A confirm password area 126C may be provided for the individual 76 to reenter the password. A confirmation indicator 127 may be displayed when the information in the password area 126B and confirm password area 126C match. The individual 76 may then enter location information in the address area 126D, city area 126E and state area 126F. The location area may be where the sprinkler system to be controlled is located, address of a business/individual using the system 70 or a corporate address. The individual 76 may press a submit button 128 via an external device 106 of the computing device78 to submit the information to the server 74 and register with the system 70.

Referring to FIGS. 10-12, the personalized dashboard page 130 may be seen. The personalized dashboard page 130 may have a weather display area 132 and a list area 134. The weather display area 132 may show the weather forecast for the area where the distribution stations 60 are installed. The weather information may be obtained from recognized weather agencies or services. The weather information may be used to alter the programming of the distribution stations 60. For example, if rain is in the forecast, one may alter the programming to not activate the distribution stations 60 or temporarily suspend the activation. For example, four temporary sleep options of 12 hours, 24 hours, 36 hours, and 48 hours may be set based on the weather forecast. It is appreciated that other periods of time may be set. The distribution stations 60 may be reawaken when the chosen sleep time has elapsed.

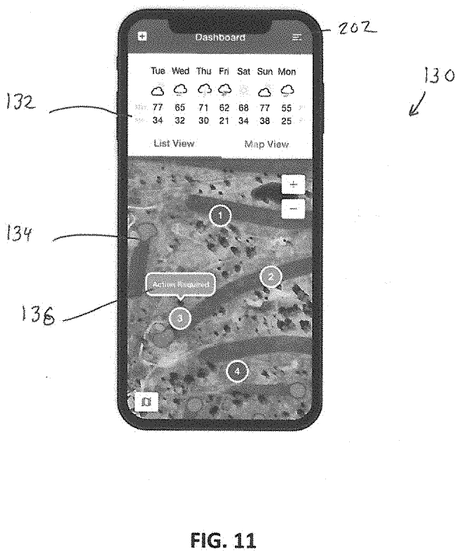

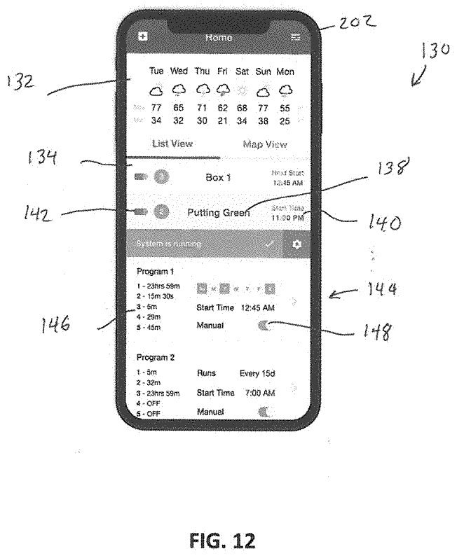

The list area 134 may show all the distribution stations 60 being controlled by a specific individual 76 subscribed to the system 70. The list area 134 may show all the distribution stations in a list structure where the distribution stations 60 may be listed one after another as shown in FIG. 12, a graphical map view as shown in FIG. 10 where the distribution stations 60 may be displayed on a graphical map or a satellite map view as shown in FIG. 11 where the distribution stations 60 may be displayed on a satellite map.

The personalized dashboard page 130 may have indicators 136. The indicators 136 may be located next to the distribution station 60 listed/displayed. The indicators 136 may show if one or more of the distribution stations 60 may need service and/or may have a potential issue. By pressing/selecting the indicator 136 the service/potential issue may be shown as will be discussed below.

Different views may display different information. As may be seen in FIG. 12, the list structure displaying the distribution stations 60 may provide additional information than the graphical map Or satellite map views. For example, in one embodiment, the personalized dashboard page 130 may have a name area 138. The name area 138 may allow one to include a name to describe each particular distribution station 60. As may be seen in FIG. 12, one of the distribution stations 60 is labeled as Box 1, while another is labeled as Putting Green, indicating that particular distribution station 60 may be used to water a putting green. A start time area 140 may be displayed. The start time area 140 may be used to show when the particular distribution station 60 is programmed to start watering. A battery indicator 142 may be shown. The battery indicators 138 may show a current battery life powering a particular distribution station 60. The above are given as examples and should not be seen in a limiting manner. Other information related to the operation of distribution station 60 may be displayed without departing from the spirit and scope of the present invention.

A Program Area 144 may allow a user to set-up one or more programming times. Each programming time may allow a user to set-up a start time, watering days, a watering time length and the like for the distribution stations 60. As may be seen in FIG. 12, multiple programs may be established and displayed wherein different distribution stations 60 may run on different programs.

The Program Area 144 show a Status Area 146. The Status Area 146 may display a current operating status of the program. The information displayed may include if the program selected is currently running, offline, or the like. The above is given as examples and should not be seen in a limiting manner.

The Program Area 144 may display the operating parameters of the program. This may include, but not limited to, the days of the week the program will water a designated area, the time the program will start watering the designated area and the like. The above is given as examples and should not be seen in, a limiting manner.

Each program may have an override switch 148. The override area 148 may allow one to override the programmed watering time and manually activate the distribution stations 60 running on the program.

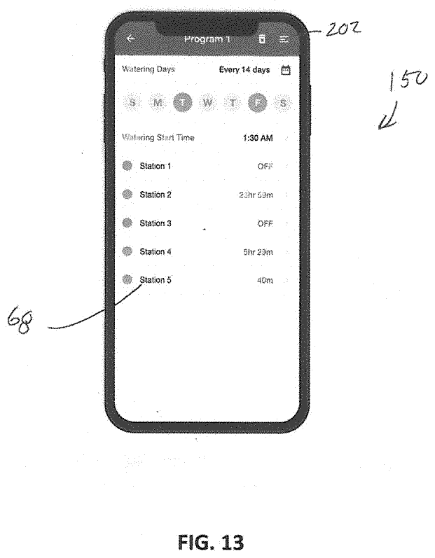

A program page 150 for a selected distribution station 60 may be seen in FIG. 13. The program page 150 may list all the valves 68 currently operating under the distribution station 60. The program page 150 may allow the individual to set-up or edit the selected program. The program page 150 may list details and allow one to edit the program such as the days the program may water the designated areas, the start time for watering the designated areas, length of time for watering, what distribution stations 60 is using the program, which valves 68 of the selected, distribution station 60 will be controlled as well as other programing information. The above is given as an example and should not be seen in a limiting manner. Once the selected program has been set-up and/or edited, the individual 76 may need to save the changes.

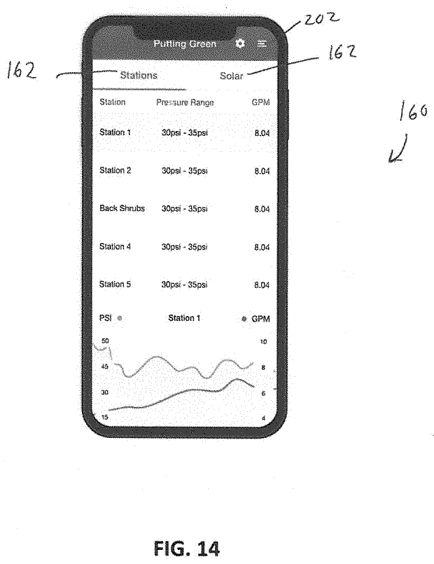

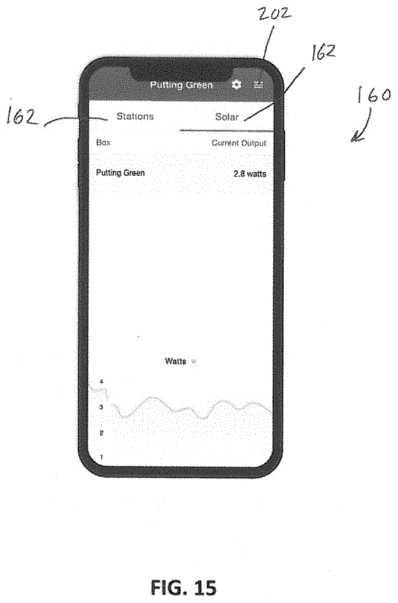

Referring to FIGS. 14-15, when an individual 76 selects one of the distribution stations 60 shown or listed on the personalized dashboard page 130, an Operating Parameter page 160 may be shown. The Operating Parameter page 160 may display different operating parameters associated with the selected distribution station 60. Different tabs 162 may be used to display different operating parameter. For example, one tab 162 on the Operating Parameter page 160 may display the water pressure and gallons/minute flowing through the valves 68 associated with the selected distribution station 60. The operating parameters may be displayed in a textual as well as graphical form as may be seen in FIG. 14. Another tab 162 may display output current from the solar panel 22 used in the selected distribution station 60. This information may be displayed in a textual as well as graphical form as may be seen in FIG. 15.

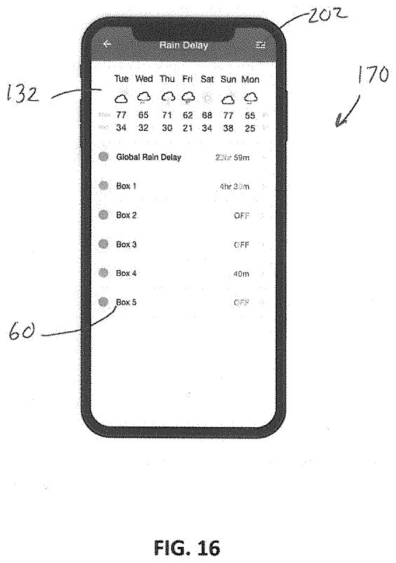

Referring to FIG. 16, a Rain Delay page 170 may be seen. As discussed above, if rain is in the forecast, one may alter the programming to not activate the distribution stations 60 or temporarily suspend the activation. The Rain Delay page 170 may allow one to individually turn on/off each of the distribution stations 60, set individual rain delay times for one, or more of the distribution stations 60, set a global delay time for all of the distribution stations 60 and the like. The above are given as examples and should not be seen in a limiting manner.

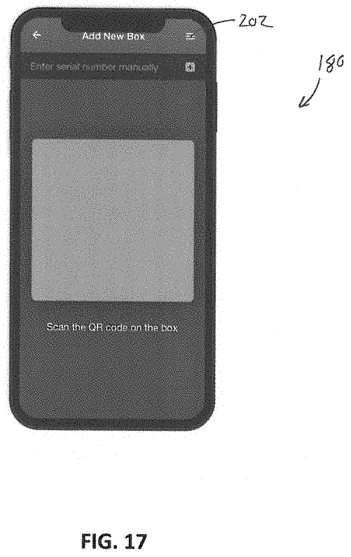

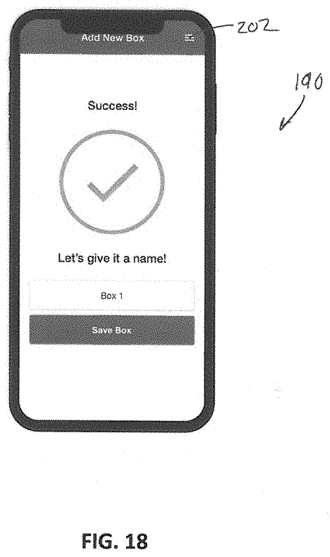

Referring to FIG. 17, a New Distribution Box page 180 may be seen. The New Distribution Box page 180 may allow one to enter a new distribution station 60 to the system 70. Identification information of the new distribution station 60 may need to be entered into the system 70. The identification information may be a serial number or identification symbol of the new distribution station 60. To enter the identification information into the system 70, the serial number may be directly inputted in the New Distribution Box page 180 and, entered. Alternatively, using a camera/scan feature on the computing device 78 a QR code may be scanned. Once the information entered is verified, the user may be taken to a Verification page 180 as may be seen, in FIG. 18. The Verification page 190 may allow the user to enter a name for the new distribution station 70 and then save it to the system 70.

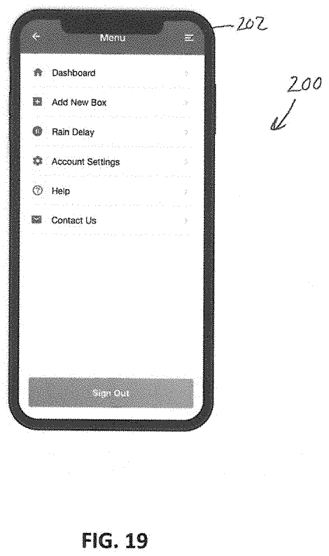

Referring to FIG. 19, a Menu page 200 may be seen. The Menu page 200 may provide tabs for directly going to any of the aforementioned pages. Thus, the Menu page 200 may have tabs to access the Dashboard page 130, the New Distribution Box page 180, a rain delay page 170, an account setting page and the like. The Menu page 200 may be accessed from any page by selecting the menu key 202.

As a person skilled in the art will recognize fro the previous detailed description and from the figures and claims, modifications and changes can be made to the preferred embodiments of the invention without departing from the scope of this invention defined in the following claims.

1. A control box for a sprinkler or irrigation systems comprising:
a housing with a base and a set of sidewalls;
a cover removably secured to the housing; and
a solar panel positioned on said cover,
one or more rechargeable batteries in said housing that are recharged by said solar panel; and
a control module powered by said one or more rechargeable batteries, the control module configured to generate control signals that actuate one or more flow control valves in the sprinkler or irrigation system.

2. The control box of claim 1 further comprising a gasket for sealing said cover to said housing.

3. The control box of claim 1 further comprising a set of threads that secure said cover to said housing.

4. The control box of claim 3 wherein said housing is in the shape of a cylindrical can.

5. The control box of claim 1 wherein said control module further comprises a digital volume and pressure sensors.

6. The control box of claim 1 wherein said control module further comprises a control panel.

7. The control box of claim 6 wherein said control panel is a touch panel display or has a set of discreet buttons.

8. The control box of claim 6 wherein said control panel further comprises a clock, clock adjustment buttons, a valve selection button to be programed, a WiFi signal indicator, a start time button, a watering day selection button, a station selection button, a calendar button, and an alert indicator.

9. The control box of claim 1 wherein said control box is configured for remote programing and operation using wireless devices.

10. The control box of claim 1 wherein said, wireless devices further comprise smartphones and tablets.

11. The control box of claim 1 wherein the control box is uniquely coded to differentiate between a plurality of said control boxes in a sprinkler or irrigation system.

12. The control box of claim 1 further comprising an application (app) that controls said control box.

13. The control box of claim 1 wherein said control box is responsive to weather alerts for scheduling operation of watering within the sprinkler or irrigation systems.

14. A sprinkler or irrigation system comprising:
one or more distribution stations each configured to be joined with a control box of claim 1, each of said distribution stations having a distribution box or valve control box that house said one or more flow control valves.

15. The system of claim 14 wherein said one or more flow control valves are offset to facilitate the removal of a malfunctioning flow control valve without having to dig up said distribution box or valve control box.

16. The system of claim 15 wherein said distribution box or valve control box further comprises a main fluid supply line that feeds into the distribution box or valve control box;
a set of taps that supply fluid to a set of nipples that are in fluid communication with said one or more flow control valves that control the flow of fluid to a set of pipes that extend outward from the distribution station.

17. The system of claim 15 comprising an application for wireless coy mun cation with each of the one or more distribution stations.

18. The system of claim 17 wherein said application displays a dashboard page listing all distribution stations being controlled by said application, said dashboard page displaying a weather display area showing weather report for an area w ere the distribution stations are installed.

19. The system of claim 17 wherein said dashboard page has a program area to set-up or edit a watering program for the distribution stations installed.

20. The system of claim 17 wherein said application displays a new distribution station page, the new distribution station page scanning an identification code on a new distribution station to be installed and added to the application.
